(19) United States
(12) Patent Application Publication
(10) Pub. No.: US 2003/0219215 A1
(43) Pub. Date: Nov. 27, 2003

(54) Optical fiber module and method of fabricating the same

(76) Inventor: Shin-Tso Han, Kaohsiung (TW)

Correspondence Address: MARTINE & PENILLA, LLP, 710 LAKEWAY DRIVE, SUITE 170, SUNNYVALE, CA, 94085, US

(21) Appl. No.: 10/155,937

(22) Filed: May 24, 2002

(51) Int. Cl. G02B 6/42

(52) U.S. Cl. 385/88

(57) ABSTRACT

The present invention provides an optical fiber module, which includes a first connector, an optical device fitted to the first connector, a second connector for connecting with the optical fiber, and a connecting portion with transparency adhered both to the first connector and the second connector by using photo-setting glue. The present invention also discloses a method of fabricating the optical fiber module described above.

### BACKGROUND OF THE INVENTION

1. Field of the Invention

The present invention relates to an optical fiber module and a method of fabricating the same and, more particularly, to an optical fiber module for emitting light or receiving light and a method of fabricating the same.

2. Description of the Related Art

Coupled with the spread of the Internet craze, the boundary between the virtual world built by the Internet and the physical world of human beings gets more and more indistinct. Based upon the data sharing and low access barrier of the Internet, all sorts of Internet applications have arisen to the real world, for instance, commercial applications such as on-line shopping, on-line banking, video conference, and mobile office, or non-commercial applications such as data search, on-line learning, on-line games and distant medical treatment. The modem Internet not only provides most of the daily necessities of the mankind, but also brings forth indefinite possibilities in future.

In the wake of various applications of the Internet, the problem to start with is the bandwidth insufficiency. Conclusive from a comprehensive survey on all kinds of communication media, optical fibers are the most capable of conforming to the requirements. According to their characteristics, namely, broad in bandwidth, low in attenuation, non-interfered by electromagnetic waves, reliable in security, small in size, and light in weight, they have become the number one choice of communication media. Therefore it is being actively used from as large as intercontinental submarine cables and Internet backbones to as small as school networks, corporate private lines, and even residential community networks.

The most essential device in optical fiber communication is the optical transceiver, which is responsible for the mutual conversion of optical signals and electronic signals. The key component therein is the optical fiber module like the optical sub-assembly (OSA). Referring to FIG. 1, the conventional optical fiber module is composed of an optical device 11 and a hollow sleeve 12. The optical device 11 is inserted and fitted to the hollow sleeve 12 and is fixed by glue, with an error approximately equal to 20 to 30 microns. The shortcoming of this method is that the glue is easily affected by temperature, humidity, or chemical reactions to become soft or deteriorate, causing a three-dimensional (X-, Y-, and Z-axes) deviation, thereby leading to optical signal loss. For the reason that this type of optical fiber modules has the above disadvantages, hence they are implemented in optical signal transmitting systems that do not demand high accuracy.

To improve such situation, manufacturers have recently developed the laser welding technique. In this case, an optical device is fitted to a connector, and then both of those are integrated with a sleeve by laser welding. An error within 1 micron can be obtained. Although this method effectively improves the deviation caused by temperature, humidity, or chemical reactions in the above-mentioned glue-and-fix method, the laser welding machines are expensive in cost, thereby significantly increasing the production cost and making it unfavorable for fast and mass production.

In view of the above-mentioned problems, it is an urgent issue to provide optical fiber modules not only with high accuracy and low production cost but also without deviations induced by temperature, humidity, or chemical reactions, and a method of fabricating the same.

### SUMMARY OF THE INVENTION

In view of the above-mentioned problems, the object of the present invention is to provide an optical fiber module with high accuracy, low production cost, and no deviation induced by temperature, humidity, or chemical reactions, and a method of fabricating the same.

To accomplish the aforesaid objects, the optical fiber module according to the present invention includes a first connector, an optical device fitted to the first connector, a second connector for connecting with an optical fiber device, and a connecting portion with transparency adhered both to the first connector and the second connector by using photo-setting glue.

In addition, the present invention also provides a method of fabricating an optical fiber module, in which the optical fiber module includes an optical device, a first connector fitted to the optical device, and a second connector for connecting with an optical fiber device. The method of fabricating the optical fiber module at first provides a connecting portion with transparency. Next, the connecting portion is adhered to the first connector by using photo-setting glue, followed by irradiating the adherence surface of the connecting portion and the first connector. Finally, the second connector is adhered to the connecting portion by using photo-setting glue, and then the adherence surface of the connecting portion and the second connector is irradiated.

In the optical fiber module and the method of fabricating the same according to the present invention, a connecting portion is added between the first connector and the second connector, so that possible deviations are restricted in the direction of connection. Therefore, it is difficult to induce any deviations in two directions (X- and Y-axes) other than the direction of connection by temperature, humidity, or chemical reactions. Moreover, it is not necessary to employ any expensive laser machine during fabrication since the photo-setting adherence method is used to replace the conventional laser welding method, thereby achieving low cost, high accuracy, no deviation induced by temperature, humidity, or chemical reactions, as well as favorableness for fast and mass production.

### BRIEF DESCRIPTION OF THE DRAWINGS

These and other objects, features, and advantages of the present invention will become apparent with reference to the following descriptions and accompanying drawings, wherein:

FIG. 1 is a decomposition diagram showing elements of a conventional optical fiber module;

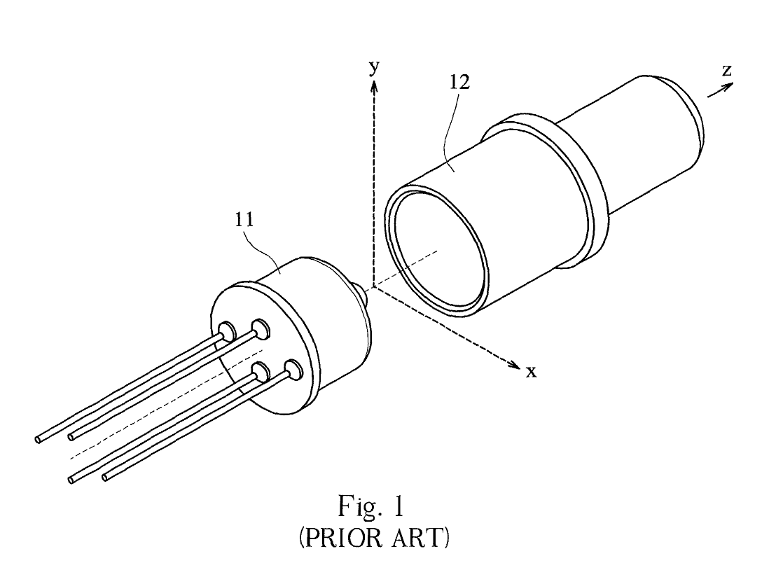

FIG. 2 is a decomposition diagram showing elements of an optical fiber module according to the embodiment of the present invention;

FIG. 3 is a schematic showing an optical fiber according to the embodiment of the present invention; and

FIG. 4 is a flow diagram showing the steps of a method of fabricating an optical fiber module according to the embodiment of the present invention.

### DETAILED DESCRIPTION OF THE PREFERRED EMBODIMENT

An optical fiber and a method of fabricating the same according to a preferred embodiment of the present invention are hereinafter illustrated with reference to accompanying figures, wherein similar elements are denoted by the same reference numerals.

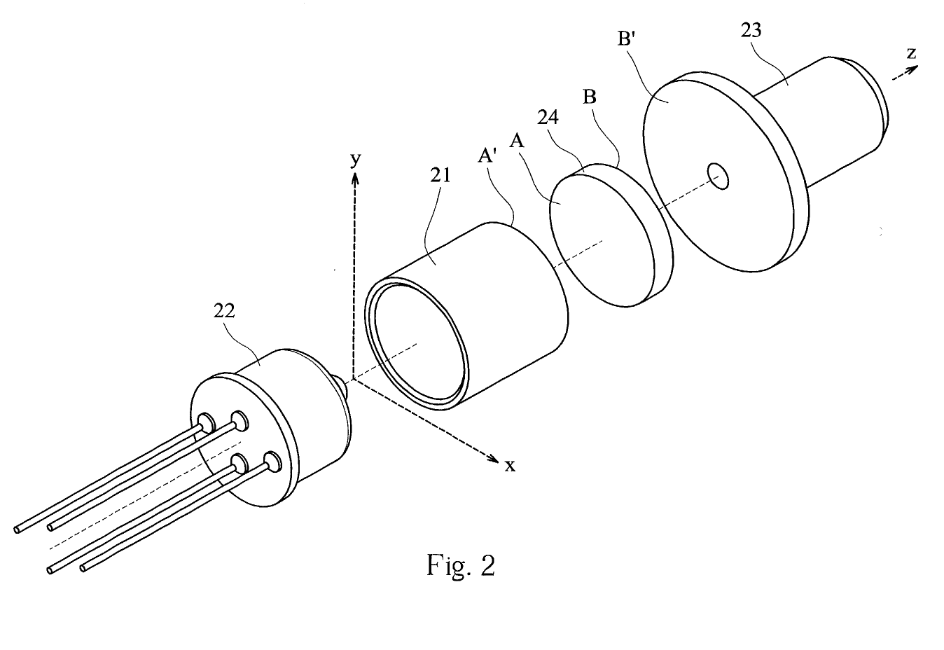

Referring to FIG. 2, the optical fiber module according to the present invention includes a first connector 21, an optical device 22 used to fit to the first connector 21, a second connector 23 used to connect with an optical fiber device, and a connecting portion 24.

At first, the first connector 21 and the optical device 22 are connected together by, for example, electric resistance welding to avoid deviations in the directions of X- and Y-axes as occurred in the prior art.

The connecting portion 24, which may be made of a transparent material such as glass, is arranged between the first connector 21 and the second connector 23. Two adherence surfaces A and B of the connecting portion 24 are applied with photo-setting glue. The adherence surfaces A and B are corresponding to the adherence surface A′ of the first connector 21 and the adherence surface B′ of the second connector 23, respectively. After it is made certain that the optical device 22 fitted to the first connector 21 is aligned with the second connector 23 and the optical signals are able to enter the optical fiber, the adherence surface A′ of the first connector 21 is connected with the adherence surface A of the connecting portion 24. Also, the adherence surface B of the connecting portion 24 is connected with the adherence surface B′ of the second connector 23 in sequence. Next, the resultant structure is irradiated with light at a particular wavelength. The light passes through the connecting portion 24 with transparency and reaches the adherence surfaces A and B, solidifying the photo-setting glue applied thereon, thereby rapidly adhering the first connector 21 to the connecting portion 24, and the connecting portion 24 to the second connector 23.

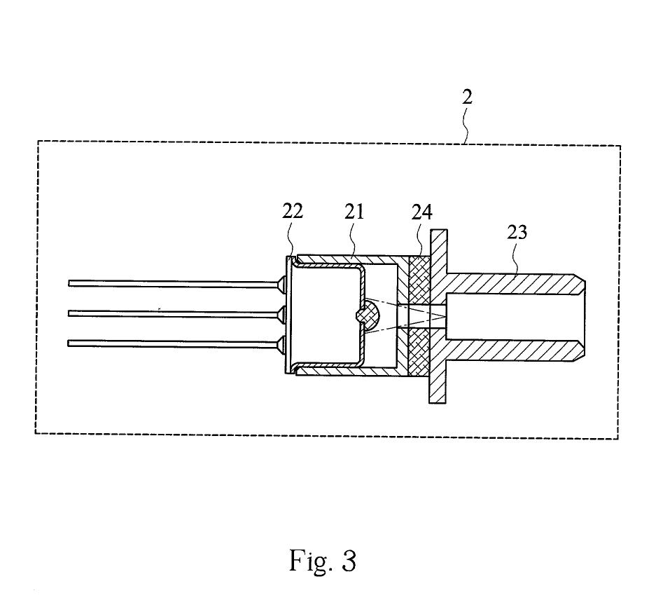

Referring to FIG. 3, the deviation of the optical fiber module 2 after the adherence is restricted in the connecting direction (Z-axis), and thus deviations in directions other than the connecting direction are never induced to make additional optical signal loss. More specifically, it is not easy to induce deviations in the optical fiber module of the present invention by effects of temperature, humidity, or chemical reactions. For the reason that the connecting portion 24 is made of a transparent material and is favorable for light to pass through, the adherence of the photo-setting glue takes place rapidly. To have the present invention understood more easily, an example is provided below to illustrate the fabrication flow of the optical fiber module according to the embodiment of the present invention.

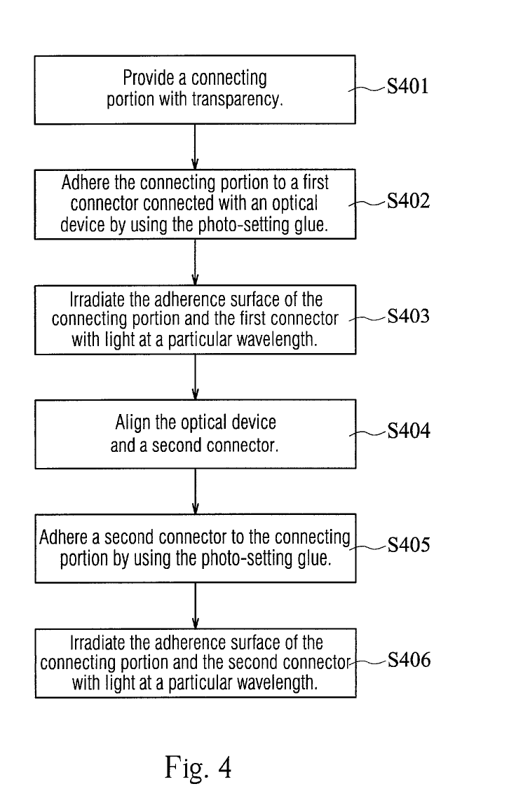

Referring to FIG. 4, the method of fabricating the optical fiber module according to the embodiment of the present invention at first provide a connecting portion 24 with transparency (S401), which may be made of a transparent material such as glass. Next, the connecting portion 24 is adhered to the first connector 21 connected with the optical device 22 by using the photo-setting glue (S402), followed by irradiating the adherence surface of the connecting portion 24 and the first connector 21 with light at a particular wavelength (S403). The light passes through the connecting portion 24 with transparency and reaches the adherence surface, solidifying the photo-setting glue applied thereon, thereby adhering the first connector 21 with the connecting portion 24. Subsequently, the optical device 22 fitted in the first connector 21 is aligned with the second connector 23 (S404) to make sure that optical signals are able to accurately enter the optical fiber, and then the second connector 23 is adhered to the connecting portion 24 (S405). Thereafter, the adherence surface of the connecting portion 24 and the second connector 23 is irradiated with light at a particular wavelength (S406) to solidify the photo-setting glue applied thereon, thereby rapidly adhering the first connector 21 and the connecting portion 24.

It should be noted that the optical device 22 in the present invention might be a light-emitting device, a light-receiving device, or a lens. In addition, the connecting portion 24 described above is not limited to glass, and any materials with transparency can be used in the present invention.

To sum up, in the optical fiber module and the method of fabricating the same according to the present invention, a connecting portion is added between the first connector and the second connector, so that possible deviations of the optical fiber module are restricted in the direction of connection (Z-axis). Therefore, it is difficult to induce any deviations in two directions (X- and Y-axes) other than the direction of connection by temperature, humidity, or chemical reactions. Moreover, it is not necessary to employ any expensive laser machine during fabrication since the photo-setting adherence method is used to replace the conventional laser welding method, thereby achieving low cost, high accuracy, no deviation induced by temperature, humidity, or chemical reactions, as well as favorableness for fast and mass production.

While the present invention has been described by way of example and in terms of the preferred embodiment, it is to be understood that the present invention is not limited to the disclosed embodiment. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An optical fiber module, comprising:
a first connector;
an optical device fitted to said first optical device;
a second connector for connecting with the optical fiber device; and
a connecting portion with transparency adhered both to said first connector and said second connector by using photo-setting glue.

2. The optical fiber module according to claim 1, wherein said optical device is a light-emitting optical device.

3. The optical fiber module according to claim 1, wherein said optical device is a light-receiving optical device.

4. The optical fiber module according to claim 1, wherein said connecting portion is made of glass.

5. A method of fabricating an optical fiber module, said optical fiber module including an optical device, a first connector fitted to said optical device, and a second connector for connecting with said optical fiber device, comprising the steps of:
providing a connecting portion with transparency;
adhering said connecting portion to said first connector by using photo-setting glue, and irradiating the adherence surface of said connecting portion and said first connector; and
adhering said second connector to said connecting portion by using photo-setting glue, and irradiating the adherence surface of said connecting portion and said second connector.

6. The method according to claim 5, further comprising the step of:
aligning said optical device and said second connector after said connecting portion is adhered to said first connector.

7. The method according to claim 5, wherein said optical device is a light-emitting optical device.

8. The method according to claim 5, wherein said optical device is a light-receiving optical device.

9. The method according to claim 5, wherein said connecting portion is made of glass.
